(19) United States
(12) Patent Application Publication
(10) Pub. No.: US 2022/0393180 A1
(43) Pub. Date: Dec. 8, 2022

(54) ANODE-FREE ALL-SOLID-STATE BATTERY INCLUDING SOLID ELECTROLYTE HAVING HIGH ION CONDUCTIVITY AND SURFACE-ROUGHENED ANODE CURRENT COLLECTOR

(71) Applicant: KOREA INSTITUTE OF SCIENCE AND TECHNOLOGY, Seoul (KR)

(72) Inventors: Sang Baek PARK, Seoul (KR); Byung Kook KIM, Seoul (KR); Jong Ho LEE, Seoul (KR); Ji Won SON, Seoul (KR); Kyung Joong YOON, Seoul (KR); Hyoung Chul KIM, Seoul (KR); HO IL JI, Seoul (KR); Sung Eun YANG, Seoul (KR); Deok Hwang KWON, Seoul (KR); Hyung Mook KANG, Seoul (KR); Dong Hee GU, Seoul (KR)

(73) Assignee: KOREA INSTITUTE OF SCIENCE AND TECHNOLOGY, Seoul (KR)

(21) Appl. No.: 17/684,300

(22) Filed: Mar. 1, 2022

(30) Foreign Application Priority Data
May 4, 2021 (KR) 10-2021-0057634

(51) Int. Cl. H01M 4/66; H01M 10/0525; H01M 4/62

(52) U.S. Cl. CPC H01M 4/661; H01M 10/0525; H01M 4/625

(57) ABSTRACT

Disclosed is an anode-free all-solid-state battery having improved charge/discharge cycle stability. Specifically, the anode-free all-solid-state battery includes a cathode layer containing a cathode active material, an anode current collector layer, and a solid electrolyte layer interposed between the cathode layer and the anode current collector layer, wherein the anode current collector layer has a surface roughness (Rq) of 100 nm to 1,000 nm.

### CROSS-REFERENCE TO RELATED APPLICATION

This application claims under 35 U.S.C. § 119(a) the benefit of priority to Korean Patent Application No. 10-2021-0057634, filed on May 4, 2021, the entire contents of which are incorporated herein by reference.

### BACKGROUND

### (a) Technical Field

The present invention relates to an anode-free all-solid-state battery having improved charge/discharge cycle stability.

### (b) Background Art

Lithium secondary battery technology is rapidly expanding from small IT devices such as mobile phones and laptops to eco-friendly electric vehicles (EVs) and large-capacity secondary batteries (ESS) for power storage devices. Lithium secondary battery technology is expected to play a pivotal role as an energy storage device that leads the next-generation energy revolution.

Currently available commercial lithium secondary batteries use organic liquid electrolytes and thus have problems associated with stability, such as flammability, corrosion, and poor resistance to temperatures.

All-solid-state batteries use solid electrolytes instead of liquid electrolytes, are capable of improving safety, are advantageous for high energy density through direct stacking, and are thus suitable for large-capacity secondary batteries for electric vehicles (EVs) and power storage devices (ESSs).

In particular, anode-free all-solid-state batteries (AFASSB), which can realize high energy density by maximizing stacking, have recently attracted a great deal of attention.

In an anode-free all-solid-state battery, the volume and weight of the cell can be reduced by removing the anode, but problems in which the electrolyte is deteriorated due to lithium deposited on an anode current collector during initial charging and in which coulombic efficiency is lowered due to dead lithium formed during repeated charge/discharge cycles should be solved.

For this purpose, attempts have been made to introduce other materials, for example, using two or more electrolytes, coating the surface of the anode current collector, or inserting a thin anode material, but cause a trade-off between an additional cost and decreased energy density due to the increased thickness.

The above information disclosed in this Background section is only for enhancement of understanding of the background of the invention, and therefore it may contain information that does not form the prior art that is already known in this country to a person of ordinary skill in the art.

### SUMMARY OF THE DISCLOSURE

The present invention has been made in an effort to solve the above-described problems associated with the prior art, and it is one object of the present invention to provide an anode-free all-solid-state battery having improved charge/discharge cycle stability.

The objects of the present invention are not limited to those described above. Other objects of the present invention will be clearly understood from the following description, and are able to be implemented by means defined in the claims and combinations thereof.

In one aspect, the present invention provides an anode-free all-solid-state battery including a cathode layer including a cathode active material, an anode current collector layer, and a solid electrolyte layer interposed between the cathode layer and the anode current collector layer, wherein the anode current collector layer has a surface roughness (Rq) of 100 nm to 1,000 nm.

The anode current collector layer may include at least one selected from the group consisting of stainless steel (SUS), titanium (Ti), nickel (Ni), and combinations thereof.

The surface roughness (Rq) of the anode current collector layer may be 180 nm to 550 nm.

In the battery, the anode current collector layer may directly contact the solid electrolyte layer.

When the anode current collector layer directly contacts the solid electrolyte layer, the ionic conductivity of the solid electrolyte layer may be 1 mS/cm to 9 mS/cm.

When the anode current collector layer directly contacts the solid electrolyte layer, the ionic conductivity of the solid electrolyte layer may be 9 mS/cm to 20 mS/cm.

The anode-free all-solid-state battery may further include a coating layer interposed between the anode current collector layer and the solid electrolyte layer, and the coating layer may contain a carbon material and a metal capable of forming an alloy with lithium.

The metal may include at least one selected from the group consisting of gold (Au), platinum (Pt), palladium (Pd), silicon (Si), silver (Ag), aluminum (Al), bismuth (Bi), tin (Sn), zinc (Zn), and combinations thereof.

The coating layer may have a thickness of 100 nm to 10 μm.

The solid electrolyte layer may have ionic conductivity of 9 mS/cm to 20 mS/cm.

Other aspects and preferred embodiments of the invention are discussed infra.

### BRIEF DESCRIPTION OF THE DRAWINGS

The above and other features of the present invention will now be described in detail with reference to certain exemplary embodiments thereof, illustrated in the accompanying drawings which are given hereinbelow by way of illustration only, and thus are not limitative of the present invention, and wherein:

FIG. 1 illustrates the discharged state of an anode-free all-solid-state battery according to a first embodiment of the present invention;

FIG. 2 illustrates the charged state of the anode-free all-solid-state battery according to the first embodiment of the present invention;

FIG. 3 illustrates the discharged state of an anode-free all-solid-state battery according to a second embodiment of the present invention;

FIG. 4 illustrates the charged state of the anode-free all-solid-state battery according to the second embodiment of the present invention;

FIG. 5 illustrates the result of analyzing cross-sections of anode current collector layers according to Examples 1 to 5 and Comparative Example with a scanning electron microscope (SEM);

FIG. 6 illustrates the result of analyzing cross-sections of anode current collector layers according to Examples 1 to 5 and Comparative Example with an atomic force microscope (AFM);

FIG. 7 illustrates the result of charging and discharging the all-solid-state battery produced in Experimental Example 1 using the anode current collector layers according to Examples 1 to 5 and Comparative Example;

FIG. 8 illustrates the result of charging and discharging the all-solid-state battery produced in Experimental Example 2 using the anode current collector layer according to Comparative Example; and

FIG. 9 illustrates the result of charging and discharging the all-solid-state battery produced in Experimental Example 2 using the anode current collector layer according to Example 2.

### DETAILED DESCRIPTION

The objects described above, as well as other objects, features, and advantages, will be clearly understood from the following preferred embodiments with reference to the attached drawings. However, the present invention is not limited to the embodiments, and may be embodied in different forms. The embodiments are suggested only to offer a thorough and complete understanding of the disclosed context and to sufficiently inform those skilled in the art of the technical concept of the present invention.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a “first” element may be referred to as a “second” element, and similarly, a “second” element may be referred to as a “first” element. Singular forms are intended to include plural forms as well, unless the context clearly indicates otherwise.

It will be further understood that terms such as “comprise” or “has”, when used in this specification, specify the presence of stated features, integers, steps, operations, elements, components, or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures, and/or expressions that represent ingredients, reaction conditions, polymer compositions, and amounts of mixtures used in the specification are approximations that reflect various uncertainties of measurement occurring inherently in obtaining these figures, among other things. For this reason, it should be understood that, in all cases, the term “about” should be understood to modify all such numbers, figures and/or expressions. In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined.

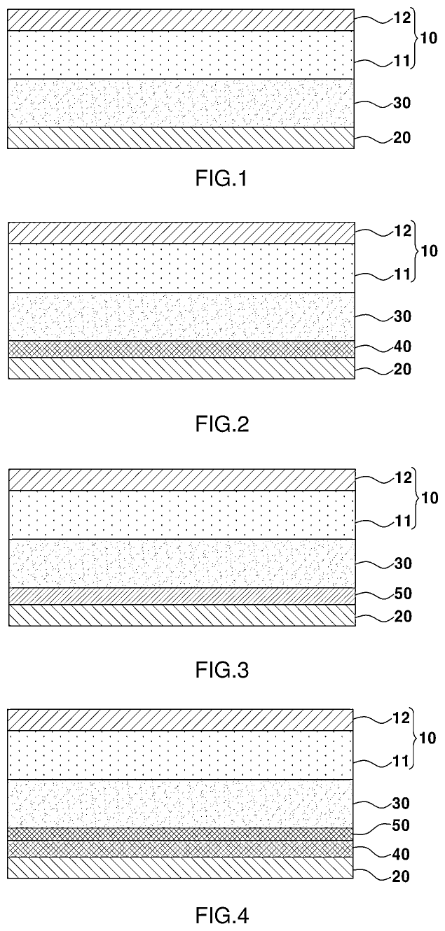

FIGS. 1 and 2 illustrate a first embodiment of an anode-free all-solid-state battery according to the present invention. Specifically, FIG. 1 illustrates the discharged state of the anode-free all-solid-state battery according to the present invention, and FIG. 2 illustrates the charged state of the anode-free all-solid-state battery according to the present invention.

The anode-free all-solid-state battery includes a cathode layer 10 including a cathode active material, an anode current collector layer 20, and a solid electrolyte layer 30 interposed between the cathode 10 and the anode current collector layer 20.

The anode-free all-solid-state battery does not contain a material serving as an anode active material, and a lithium layer 40 is deposited between the anode current collector layer 20 and the solid electrolyte layer 30 when charged, as shown in FIG. 2.

The cathode layer 10 may include a cathode active material layer 11 containing a cathode active material and a cathode current collector layer 12.

The cathode active material layer 11 may contain a cathode active material, a solid electrolyte, a conductive material, a binder, and the like.

The cathode active material may be an oxide active material or a sulfide active material.

The oxide active material may be a rock-salt-layer-type active material such as LiCoO₂, LiMnO₂, LiNiO₂, LiVO₂, or Li₁₊ₓNi_{1/3}Co_{1/3}Mn_{1/3}O₂, a spinel-type active material such as LiMn₂O₄ or Li(Ni_{0.5}Mn_{1.5})O₄, a reverse-spinel-type active material such as LiNiVO₄ or LiCoVO₄, an olivine-type active material such as LiFePO₄, LiMnPO₄, LiCoPO₄, or LiNiPO₄, a silicon-containing active material such as Li₂FeSiO₄ or Li₂MnSiO₄, a rock-salt-layer-type active material having a transition metal, a portion of which is substituted with a heterogeneous metal such as LiNi_{0.8}Co_{(0.2-x)}AlₓO₂ (0<x<0.2), a spinel-type active material having a transition metal, a portion of which is substituted with a heterogeneous metal such as Li₁₊ₓMn_{2-x-y}M_{y}O₄ (wherein M includes at least one of Al, Mg, Co, Fe, Ni, Zn, and 0<x+y<2), and lithium titanate, such as Li₄Ti₅O₁₂.

The sulfide active material may be copper Chevrel, iron sulfide, cobalt sulfide, nickel sulfide, or the like.

The solid electrolyte may be an oxide solid electrolyte or a sulfide solid electrolyte. However, preferred is the use of a sulfide solid electrolyte, which has high lithium ion conductivity. The sulfide solid electrolyte is not particularly limited, but may be Li₂S—P₂S₅, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, , Li₂S—SiS—P₂S₅—LiI, Li₂S—B₂S₃, Li₂S—P₂S₃—ZₘSₙ (wherein m and n are positive numbers and Z is one of Ge, Zn and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), Li₁₀GeP₂S₁₂, or the like.

The conductive material may be carbon black, conductive graphite, ethylene black, graphene, or the like.

The binder may be butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), polyethylene oxide (PEO), or the like.

The cathode current collector layer 12 may be a plate-shaped substrate having electrical conductivity. The cathode current collector layer 12 may include aluminum foil.

The anode current collector layer 20 may have a surface roughness (Rq) of 100 nm to 1,000 nm, preferably 180 nm to 550 nm.

Anode current collectors such as copper foil and stainless steel foil used in conventional lithium secondary batteries have a flat and smooth surface for uniform application of an active material. However, in an anode-free all-solid-state battery, when the surface of the anode current collector is flat, lithium, a charging product, is deposited immediately on the surface of the anode current collector, so there are few nucleation sites and thus nucleation overpotential increases, resulting in nonuniform deposition of lithium.

Accordingly, the present invention is designed such that lithium is uniformly deposited on the anode current collector layer 20 using the anode current collector layer 20 having a rough surface, unlike the anode current collector used in conventional lithium secondary batteries. The stability of the charge/discharge cycle is improved.

Meanwhile, the conventional anode-free all-solid-state battery further includes a separate layer capable of inducing uniform movement of lithium ions between the solid electrolyte layer and the anode current collector for uniform deposition of lithium. For example, a technique of forming a layer having a predetermined thickness between a solid electrolyte layer and an anode current collector using a mixture of amorphous carbon and a metal powder such as silver is known.

As described above, the present invention is capable of uniformly depositing lithium on the anode current collector layer 20 without a separate layer, as described above, by increasing the surface roughness Rq of the anode current collector layer 20. That is, in the anode-free all-solid-state battery according to the present invention, the anode current collector layer 20 directly contacts the solid electrolyte layer 30. Accordingly, the present invention can provide an anode-free all-solid-state battery having improved energy density per unit weight and volume compared to the prior art.

The type of the anode current collector layer 20 is not particularly limited, but the anode current collector layer 20 may include, for example, at least one selected from the group consisting of stainless steel (SUS), titanium (Ti), nickel (Ni), and combinations thereof.

In addition, the method of increasing the surface roughness Rq of the anode current collector layer 20 is not particularly limited, and the anode current collector layer 20 may be etched using a physical or chemical method. For example, the surface treatment may be performed by floating the anode current collector layer 20 in an acidic etchant or immersing the same in the etchant for a predetermined period of time. The surface roughness (Rq) can be adjusted to a desired level by varying the acidity, immersion time, or the like.

The solid electrolyte layer 30 is interposed between the cathode layer 10 and the anode current collector layer 20 to allow lithium ions to move therebetween.

The solid electrolyte layer 10 may be an oxide solid electrolyte or a sulfide solid electrolyte. However, preferred is the use of a sulfide solid electrolyte, which has high lithium ion conductivity. The sulfide solid electrolyte is not particularly limited, but may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn, and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), Li₁₀GeP₂S₁₂, or the like.

The lithium ion conductivity of the solid electrolyte layer 30 is not particularly limited, but may be, for example, 1 mS/cm to 9 mS/cm. The lithium ion conductivity of the solid electrolyte layer 30 may be the lithium ion conductivity of the solid electrolyte contained therein or the lithium ion conductivity of the solid electrolyte layer 30 including the solid electrolyte and the binder.

Meanwhile, the anode-free all-solid-state battery according to the present invention can be stably charged and discharged even when a solid electrolyte layer 30 having high ionic conductivity is used. Specifically, the solid electrolyte layer 30 having high ionic conductivity may have a lithium ion conductivity of 9 mS/cm to 20 mS/cm.

FIGS. 3 and 4 illustrate a second embodiment of an anode-free all-solid-state battery according to the present invention. Specifically, FIG. 3 illustrates the discharged state of the anode-free all-solid-state battery and FIG. 4 illustrates the charged state of the anode-free all-solid-state battery.

The anode-free all-solid-state battery includes a cathode layer 10, an anode current collector layer 20, a solid electrolyte layer 30 interposed between the cathode 10 layer and the anode current collector layer 20, and a coating layer 50 interposed between the anode current collector layer 20 and the solid electrolyte layer 30.

The anode-free all-solid-state battery does not contain a material serving as an anode active material, and a lithium layer 40 is deposited between the anode current collector layer 20 and the coating layer 50, as shown in FIG. 4, when charged.

The anode-free all-solid-state battery according to the second embodiment of the present invention is a combination of the anode current collector layer 20 having a surface roughness (Rq) of 100 nm to 1,000 nm and the solid electrolyte layer 30 having high lithium ion conductivity. As the lithium ion conductivity of a solid electrolyte increases, the solid electrolyte becomes more unstable and is easily decomposed. Accordingly, materials having high lithium ion conductivity of 10 mS/cm have been developed, but are appropriate for use in all-solid-state batteries without an anode. When the anode current collector layer 20 having high surface roughness (Rq) according to the present invention is used, an anode-free all-solid-state battery having excellent charge/discharge cycle stability can be obtained even when using a solid electrolyte having high lithium ion conductivity. As a result, the energy density and the charge/discharge efficiency of the anode-free all-solid-state battery can be remarkably improved.

The lithium ion conductivity of the solid electrolyte layer 30 may be 9 mS/cm to 20 mS/cm.

The coating layer 50 is configured to induce lithium ions to be uniformly deposited on the anode current collector layer 20 during charging of the anode-free all-solid-state battery. The coating layer 50 may include a carbon material and a metal capable of forming an alloy with lithium.

The metal may include at least one selected from the group consisting of gold (Au), platinum (Pt), palladium (Pd), silicon (Si), silver (Ag), aluminum (Al), bismuth (Bi), tin (Sn), zinc (Zn), and combinations thereof.

The thickness of the coating layer 50 is not particularly limited, but may be 100 nm to 10 μm.

Hereinafter, the present invention will be described in more detail with reference to specific examples. However, the following examples are provided only for better understanding of the present invention, and thus should not be construed as limiting the scope of the present invention.

### EXAMPLES 1 TO 5 AND COMPARATIVE EXAMPLE

An anode current collector layer made of stainless steel (SUS) was prepared. This was used as Comparative Example.

By etching the surface of the anode current collector layer, the surface roughness (Rq) was adjusted as shown in Table 1 below. The method of etching each sample is also shown in Table 1.

TABLE 1

| Item | Etching method | Surface roughness (Rq) | |
|---|---|---|---|
| Comparative | No treatment | 21 | nm |
| Example | | | |
| Example 1 | Floating in strong acidic etchant | 137 | nm |
| Example 2 | Floating in weak acidic etchant | 180 | nm |
| Example 3 | Floating in general etchant | 227 | nm |
| Example 4 | Immersed in etchant | 232 | nm |
| | for short time | | |
| Example 5 | Immersed in etchant | 536 | nm |
| | for short time | | |

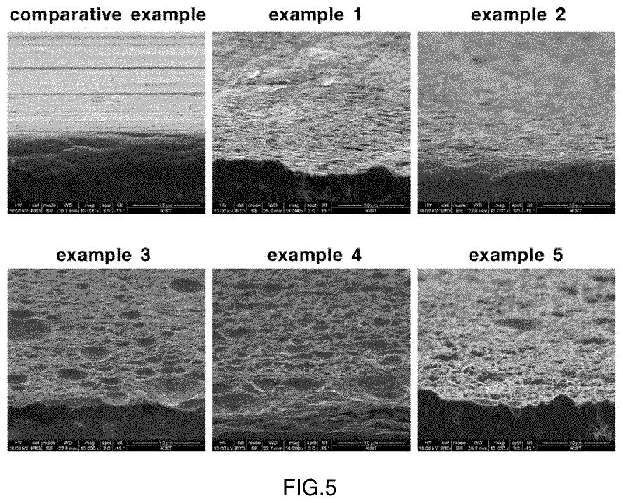

The cross-sections of the anode current collector layers according to Examples 1 to 5 and Comparative Example were analyzed with a scanning electron microscope (SEM). The result is shown in FIG. 5.

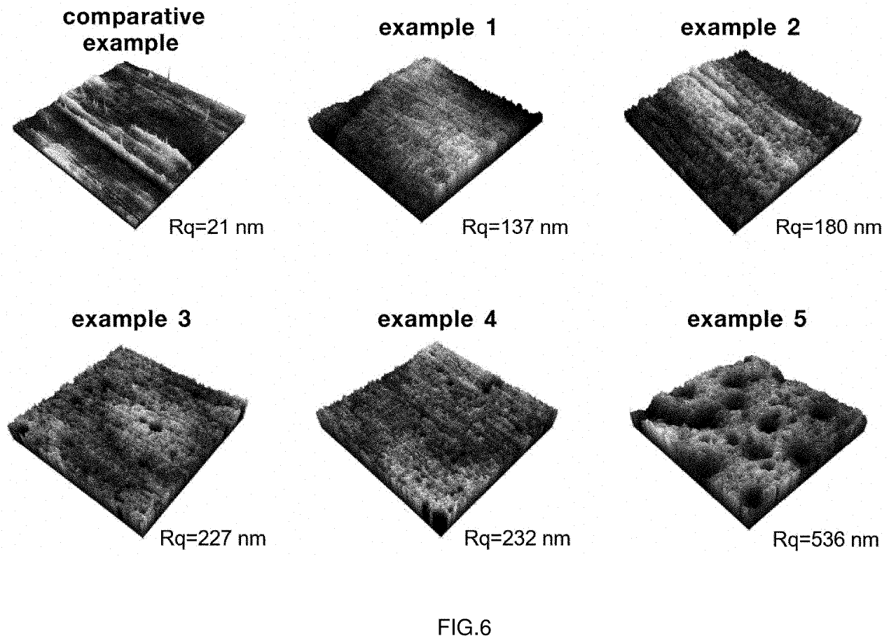

In addition, the cross-sections of the anode current collector layers according to Examples 1 to 5 and Comparative Example were analyzed using an atomic force microscope (AFM). The result is shown in FIG. 6.

As can be seen from FIGS. 5 and 6, the surfaces of each of the anode current collector layers of Examples 1 to 5 were rougher than that of Comparative Example.

### Experimental Example 1

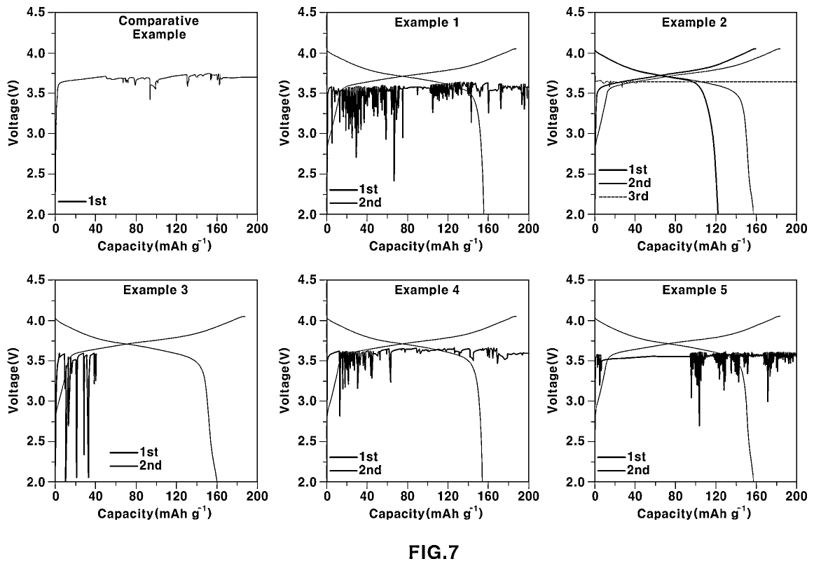

An anode-free all-solid-state battery in which the anode current collector layer directly contacted the solid electrolyte layer was prepared using each of the anode current collector layers according to Examples 1 to 5 and Comparative Example, as shown in FIG. 1. Each battery was subjected to a charging/discharging test. The result is shown in FIG. 7.

As can be seen from FIG. 7, the battery of Comparative Example is infinitely charged in the first cycle of charging and discharging, whereas the batteries of Examples 1 to 5 are charged and discharged without infinite charging.

### Experimental Example 2

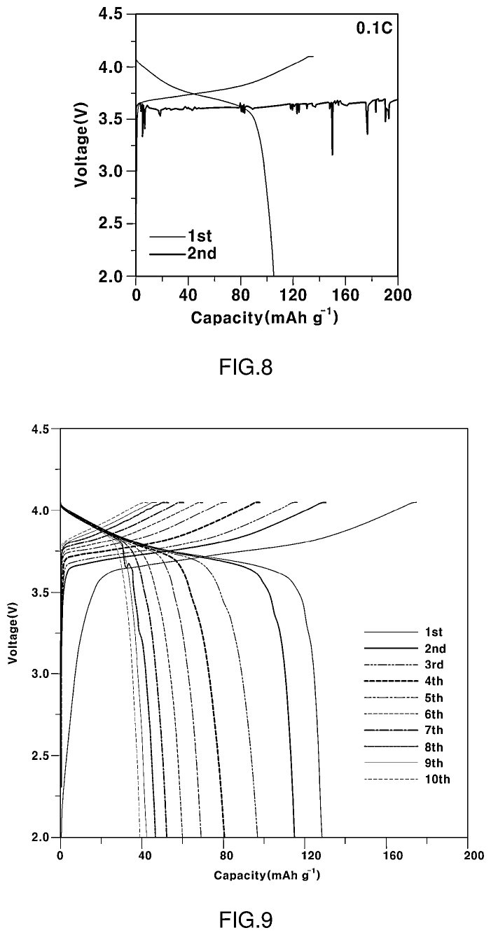

An anode-free all-solid-state battery including a coating layer interposed between the anode current collector layer and the solid electrolyte layer was prepared using the anode current collector layer according to Example 2 and Comparative Example, as shown in FIG. 3. In this case, a solid electrolyte layer containing a solid electrolyte having a composition of Li_{5.5}PS_{4.5}Cl_{1.5} and having lithium ion conductivity of about 9 mS/cm to 10 mS/cm was used. A coating layer was formed by mixing amorphous carbon with a silver (Ag) powder. Each battery was subjected to a charging/discharging test. FIG. 8 illustrates the result of Comparative Example, and FIG. 9 illustrates the result of Example 2.

As can be seen from FIG. 8, the battery of Comparative Example exhibited excessively high lithium ion conductivity of the solid electrolyte layer even though the coating layer was present, so infinite charging occurred from the second charge/discharge cycle.

On the other hand, as can be seen from FIG. 9, the battery of Example 2 exhibited a very stable charge/discharge cycle without infinite charging even though a solid electrolyte having high ionic conductivity was used.

The present invention is capable of stably charging and discharging the anode-free all-solid-state battery by increasing the surface roughness (Rq) of the anode current collector layer, without inserting a separate intermediate layer between the anode current collector layer and the solid electrolyte layer.

In addition, the present invention is capable of implementing an anode-free all-solid-state battery that can be stably charged and discharged even when using a solid electrolyte having high lithium ion conductivity.

The effects of the present invention are not limited to those mentioned above. It should be understood that the effects of the present invention include all effects that can be inferred from the description of the present invention.

The present invention has been described in detail with reference to embodiments thereof. However, it will be appreciated by those skilled in the art that changes may be made in these embodiments without departing from the principles and spirit of the present invention, the scope of which is defined in the appended claims and their equivalents.

What is claimed is:

1. An anode-free all-solid-state battery comprising:
a cathode layer containing a cathode active material;
an anode current collector layer; and
a solid electrolyte layer interposed between the cathode layer and the anode current collector layer,
wherein the anode current collector layer has a surface roughness (Rq) of 100 nm to 1,000 nm.

2. The anode-free all-solid-state battery according to claim 1, wherein the anode current collector layer comprises at least one selected from the group consisting of stainless steel (SUS), titanium (Ti), nickel (Ni), and combinations thereof.

3. The anode-free all-solid-state battery according to claim 1, wherein the surface roughness (Rq) of the anode current collector layer is 180 nm to 550 nm.

4. The anode-free all-solid-state battery according to claim 1, wherein the anode current collector layer directly contacts the solid electrolyte layer.

5. The anode-free all-solid-state battery according to claim 1, wherein the solid electrolyte layer has an ionic conductivity of 1 mS/cm to 9 mS/cm.

6. The anode-free all-solid-state battery according to claim 1, wherein the solid electrolyte layer has an ionic conductivity of 9 mS/cm to 20 mS/cm.

7. The anode-free all-solid-state battery according to claim 1, further comprising a coating layer interposed between the anode current collector layer and the solid electrolyte layer,
wherein the coating layer comprises a carbon material and a metal capable of forming an alloy with lithium.

8. The anode-free all-solid-state battery according to claim 7, wherein the metal comprises at least one selected from the group consisting of gold (Au), platinum (Pt), palladium (Pd), silicon (Si), silver (Ag), aluminum (Al), bismuth (Bi), tin (Sn), zinc (Zn) and combinations thereof.

9. The anode-free all-solid-state battery according to claim 7, wherein the coating layer has a thickness of 100 nm to 10 μm.

10. The anode-free all-solid-state battery according to claim 7, wherein the solid electrolyte layer has ionic conductivity of 9 mS/cm to 20 mS/cm.
